(19) United States
(12) Patent Application Publication
(10) Pub. No.: US 2026/0064128 A1
(43) Pub. Date: Mar. 5, 2026

(54) METHOD AND DEVICE BASED ON ISCC FOR CLOSED LOOP CONTROL OF MULTIPLE INTELLIGENT MACHINES

(71) Applicant: Beijing University of Posts and Telecommunications, Beijing (CN)

(72) Inventors: Zhiyong FENG, Beijing (CN); Zhiqing WEI, Beijing (CN); Ying ZHOU, Beijing (CN); Dingyou MA, Beijing (CN); Zeyang MENG, Beijing (CN); Yanpeng CUI, Beijing (CN); Ping ZHANG, Beijing (CN)

(21) Appl. No.: 19/316,027

(22) Filed: Sep. 2, 2025

(30) Foreign Application Priority Data
Sep. 3, 2024 (CN) 202411225976.9

(51) Int. Cl. G05D 1/622; G05D 1/646; G05D 1/65; G05D 107/70

(52) U.S. Cl. CPC G05D 1/622; G05D 1/646; G05D 1/65; G05D 2107/70

(57) ABSTRACT

The present invention provides a method and device based on ISCC for closed-loop control of multiple intelligent machines, relating to the technical field of ISCC, the method including: in response to determining that a first mobile terminal meets a first condition, receiving a first control instruction sent by a communication network device, the first control instruction is used to instruct to adjust a motion trajectory and a motion speed of the first mobile terminal within a target motion period; in response to determining that the first mobile terminal does not meet the first condition, adjusting the motion trajectory and the motion speed of the first mobile terminal within the target motion period based on a sensor-sensed first motion state observation value of the first mobile terminal and/or a sensor-sensed second motion state observation value of a second mobile terminal.

### TECHNICAL FIELD

The present invention relates to the technical field of integrated sensing, communication, and control (ISCC), and in particular to a method and device based on ISCC for closed-loop control of multiple intelligent machines.

### BACKGROUND

With the widespread application and development of technologies such as mobile communication and edge computing in the manufacturing industry, intelligent machines and mobile platforms, such as automated guided vehicles (AGVs), are deployed on a large scale in an intelligent factory, to free up human resources and effectively improve workshop production efficiency. In addition, by introducing a networked control system (NCS), the intelligent factory adopts a centralized management model to achieve networked closed-loop control of AGVs such that AGVs efficiently perform industrial tasks such as material transportation and collaborative assembly. The closed-loop control process includes the AGV periodically uploading sensed data to an edge server on the base station side through a wireless communication network, and receiving and executing control commands from a built-in programmable logic controller (PLC) in the edge server. However, as factory production scale and production capacity demand increase, the requirement for the number of controllable AGVs and the working speed surges, with the failure rate and risk of loss of control in a large AGV closed-loop control system also increasing. Therefore, to meet the low-latency and efficient real-time control requirements of AGV closed-loop control system, it is necessary to collaboratively design the sensing, communication, and control systems in the AGV closed-loop control process, which involves both sensing-control collaboration and communication-control collaboration, aiming to minimize resource consumption and improve control performance.

Specifically, the existing closed-loop control schemes with sensing-control collaboration only consider that the AGV moves along a fixed path and may require extensive infrastructure modifications to enable the AGV to navigate a new path. Under this production model, the AGV system has a high deployment cost, a relatively low cumulative control error, and a low requirement for performance of the communication system, and a relatively simple network structure model is involved. However, with the large-scale deployment of mobile intelligent machines such as AGVs in a manufacturing workshop, the number of retransmissions and a risk of congestion, collision, and loss of control have increased dramatically, and there are a problem that the complex physical environment and limited communication resources cannot meet the requirements of large-scale intelligent terminals to for efficiently executing industrial tasks and a problem of the real-time control of AGVs.

The existing closed-loop control schemes with communication-control collaboration focus on studying parameters such as air interface latency and reliability within an unidirectional link, and ignores the closed-loop interactive nature of closed-loop information flows for actual intelligent machines, which makes it difficult for intelligent machine networks to meet the requirement for efficient information flow interaction. For a small-scale AGV closed-loop control system, the existing closed-loop control schemes under these simple network structures are already very detailed and can meet the requirements for real-time and efficient control of low-density AGVs in a manufacturing workshop. However, as the requirement such as the number of AGVs and the working speed increase, most work has ignored a coupling relationship among communication, sensing and control, particularly failing to consider the degree to which different industrial tasks depend on communication performance, control, and sensing errors, thus further resulting in the transmission of excessive redundant data, increased communication overhead, and exponentially increased end-to-end latency. The control system cannot meet the requirements for efficient and stable closed-loop interaction among large-scale intelligent machines.

In summary, the existing mobile terminal (such as AGV) control systems have the problems of poor control performance and high resource consumption.

### SUMMARY

The purpose of the present invention is to provide a method and device based on ISCC for closed-loop control of multiple intelligent machines, to solve the problems of poor control performance and high resource consumption of the existing mobile terminal control systems.

To solve the above technical problems, embodiments of the present invention provide the following technical solutions.

An embodiment of the present invention provides a method based on ISCC for closed-loop control of multiple intelligent machines, which is applied to a first mobile terminal, the method including:
in response to determining that the first mobile terminal meets a first condition, receiving a first control instruction sent from a communication network device, wherein the first control instruction is used to instruct to adjust a motion trajectory and a motion speed of the first mobile terminal within a target motion period, and wherein a duration of the target motion period is a preset duration; and
in response to determining that the first mobile terminal does not meet the first condition, adjusting the motion trajectory and the motion speed of the first mobile terminal within the target motion period based on a sensor-sensed first motion state observation value of the first mobile terminal and/or a sensor-sensed second motion state observation value of a second mobile terminal, wherein the second mobile terminal is a motion terminal preceding and adjacent to the first mobile terminal, and wherein a duration of the target motion period is a first duration which is determined based on control environment state information within a workshop where the first mobile terminal is located;
wherein, the first condition includes at least one of:
   the first mobile terminal being located in an assembly area within the workshop; and
   the first mobile terminal being located in a steering area on an assembly line within the workshop.

An embodiment of the present invention further provides a device based on ISCC for closed-loop control of multiple intelligent machines, including a transceiver, a processor, a memory and programs or instructions stored in the memory and executable on the processor, wherein the programs or instructions, when executed by the processor, carry out the method based on ISCC for closed-loop control of multiple intelligent machines.

An embodiment of the present invention further provides a readable storage medium having programs or instructions stored thereon, which, when executed by a processor, carry out the method based on ISCC for closed-loop control of multiple intelligent machines.

The beneficial effects of the above technical solutions of the present invention are as follows:
With the method based on ISCC for closed-loop control of multiple intelligent machines provided by the solution of the present invention, in response to determining that the first mobile terminal meets the first condition (the first mobile terminal is located in the assembly area within the workshop and/or the first mobile terminal is located in the steering area on the assembly line within the workshop), the first mobile terminal receives the first control instruction sent from the communication network device, wherein the first control instruction is used to instruct to adjust the motion trajectory and the motion speed of the first mobile terminal within the target motion period, that is, the first mobile terminal passively adjusts its motion trajectory and motion speed within the target motion period based on the first control instruction; in response to determining that the first mobile terminal does not meet the first condition, the first mobile terminal adjusts the motion trajectory and the motion speed of the first mobile terminal within the target motion period based on the sensor-sensed first motion state observation value of the first mobile terminal and/or the sensor-sensed second motion state observation value of the second mobile terminal, that is, through the auxiliary control of the first mobile terminal, an active decision is selected, to actively control the motion trajectory and motion speed of the first mobile terminal. Through combination of active adjustment and passive adjustment, it solves the problem that the complex physical environment and limited communication resources cannot meet the requirements of large-scale intelligent terminals for efficiently executing industrial tasks, and solves the problem of poor control stability due to the intelligent terminal being unable to respond to the environment quickly. In the active decision, the first duration of the target motion period is determined based on the control environment state information within the workshop where the first mobile terminal is located, that is, the duration of the motion period is adaptively adjusted, to reduce the number of accesses of the mobile terminal to the base station and overhead, expand the number of mobile terminals that can be controlled by the network, improve workshop production capacity, and reduce resource consumption.

### BRIEF DESCRIPTION OF THE DRAWINGS

FIG. 1 is a flow chart of a method based on ISCC for closed-loop control of multiple intelligent machines provided by an embodiment of the present invention;

FIG. 2 is a schematic structural diagram of a final assembly workshop in an automobile flexible manufacturing provided by an embodiment of the present invention;

FIG. 3 is a schematic diagram of a congestion and collision probability with different AGV spacing provided by an embodiment of the present invention;

FIG. 4 is a schematic diagram showing a comparison between a duration of a traditional closed-loop interaction cycle time and a duration of a closed-loop interaction cycle time obtained by the present invention, provided by an embodiment of the present invention;

FIG. 5 is a schematic diagram showing a comparison among the number of controllable AGVs for different schemes provided by an embodiment of the present invention;

FIG. 6 is a schematic diagram showing a comparison among closed-loop communication latency for different schemes provided by an embodiment of the present invention;

FIG. 7 is a structural schematic diagram of a device based on ISCC for closed-loop control of multiple intelligent machines provided by an embodiment of the present invention.

### DETAILED DESCRIPTION

In order to make the technical problems to be solved, technical solutions and advantages of the present application clearer, the present application will be described in more detail below with reference to the accompanying drawings and specific embodiments.

To solve the problems that the existing complex physical environment and limited communication resources cannot meet the requirements of large-scale intelligent terminals for efficiently executing industrial tasks and the problem of poor control stability, an embodiment of the present invention provides a method and device based on ISCC for closed-loop control of multiple intelligent machines.

As shown in FIG. 1, an embodiment of the present invention provides a method based on ISCC for closed-loop control of multiple intelligent machines, which is applied to a first mobile terminal, the method including:
Step 101: in response to determining that the first mobile terminal meets a first condition, receiving a first control instruction sent from a communication network device, wherein the first control instruction is used to instruct to adjust a motion trajectory and a motion speed of the first mobile terminal within a target motion period, and wherein a duration of the target motion period is a preset duration; and
in response to determining that the first mobile terminal does not meet the first condition, adjusting the motion trajectory and the motion speed of the first mobile terminal within the target motion period based on a sensor-sensed first motion state observation value of the first mobile terminal and/or a sensor-sensed second motion state observation value of a second mobile terminal, wherein the second mobile terminal is a motion terminal preceding and adjacent to the first mobile terminal, and wherein a duration of the target motion period is a first duration which is determined based on control environment state information within a workshop where the first mobile terminal is located;
wherein, the first condition includes at least one of:
   the first mobile terminal being located in an assembly area within the workshop; and
   the first mobile terminal being located in a steering area on an assembly line within the workshop.

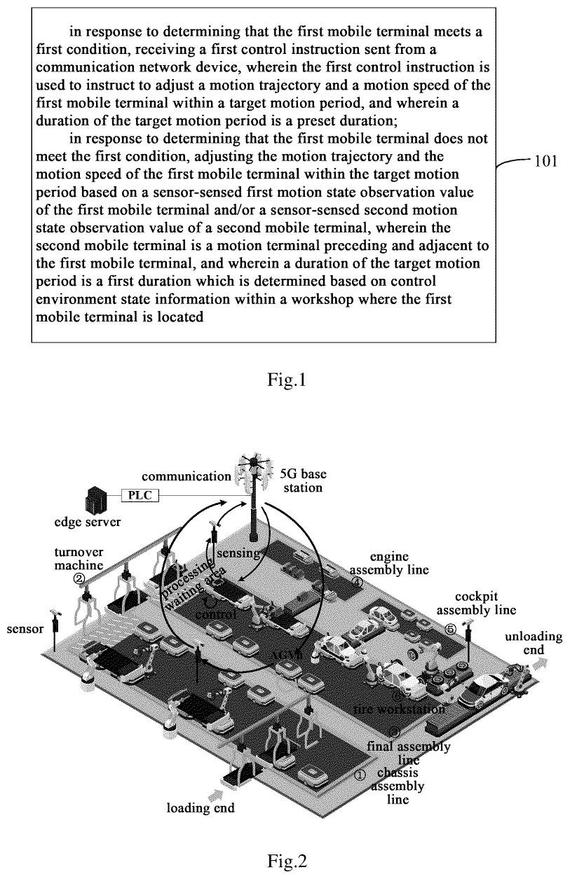

It should be noted that the first mobile terminal is any one of mobile terminals in the workshop which can be an AGV or an intelligent AGV, and the communication network device can be a 5G base station, an edge server or a PLC device on an edge server. In the embodiment of the present invention, the description is made by taking the mobile terminal being the AGV as an example, taking the communication network device being the PLC as an example, and taking the workshop being a final assembly workshop for an automobile manufacturing as an example. To accurately describe a closed-loop control process of the AGV in an industrial environment, taking a scenario where AGVs transport materials in the final assembly workshop for the automobile manufacturing for illustration, a new type of closed-loop control system model based on ISCC is established. A structure of a final assembly workshop for an automobile flexible manufacturing is shown in FIG. 2. There are four assembly lines in the workshop, namely a chassis assembly line, a final assembly line, an engine assembly line and a cockpit assembly line. At least one AGV is provided on each assembly line, and the AGV may travel along a annular or rectangular assembly line on the assembly line. The assembly area includes an assembly area on the chassis assembly line, an assembly area on the final assembly line, an assembly area on the engine assembly line, and an assembly area on the cockpit assembly line. An loading end area, an turnover machine area, and an unloading end area are also included in the workshop. Multiple sensors and a base station are provided in the workshop. Data from the multiple sensors is uploaded to the base station, which then communicates with the PLC on the edge server to transmit data therebetween.

During the closed-loop control process of the AGV, there exist mutual influences among a sensing system, a communication network and a control system. Independent redundant designs for sensing, communication and control can lead to significant waste of resources, resulting in a problem of a surge in the number of retransmissions and in a risk of congestion, collision, and loss of control, a problem of high communication overhead, and a problem of an exponential increase of end-to-end latency.

In order to solve the above technical problems, in this step, it is determined whether a first AGV (i.e., the first mobile terminal) is located in the assembly area in the workshop, or whether the first AGV is located in the steering area on the assembly line in the workshop, or whether the first AGV is located in both the assembly area in the workshop and the steering area on the assembly line in the workshop. Based on the above determination result, active local control decision (active closed-loop control) or passive reception of control decision from PLC (passive closed-loop control) is intelligently selected.

The target motion period is any motion period which is one closed-loop interaction cycle time. Within the target interaction cycle, it is determined whether the above first condition is met, so as to trigger active closed-loop control and passive closed-loop control. If the first condition is met, for example, if the first AGV is located in the assembly area, the AGV will receive a part assembly task to collaborate with intelligent machines such as a robotic arm and turnover machine, etc. The assembly task requires the AGV to frequently communicate with the communication network device in a fixed closed-loop interaction cycle time, and continuously calibrate its own trajectory and positioning information to achieve high-precision control synchronization with the robotic arm, etc., that is, the first AGV receives the first control instruction sent from the communication network device, and the duration of the target motion period is fixed and is the preset duration which is relatively short, such as 4 ms; the first AGV adjusts the motion trajectory and motion speed within the preset duration according to the first control instruction, and moves slowly and with a high-precision in a cyclic step-by step manner within the preset duration, so as to ensure the efficient operation of production process. If the first condition is met, for example, if the first AGV is located in a linear motion area on the assembly line and in a non-assembly area, since AGVs in this area are all operating in a stable state and there are no robotic arm assembly station or other obstacles (such as other AGVs) between any AGV, the first AGV adjusts its own motion trajectory and motion speed by taking an AGV active control as primary control and taking the second AGV (the second mobile terminal) as an obstacle avoidance target, that is, the motion trajectory and motion speed of the first AGV are adjusted according to the motion state observation value of the first AGV and the motion state observation value of the second AGV.

The second AGV is an AGV preceding and adjacent to the first AGV. “Preceding and adjacent to” can be understood as the second AGV and the first AGV being located on the same assembly line, the second AGV moves preceding the first AGV, and the second AGV is adjacent to the first AGV.

The motion state observation value includes at least one of:
a position of the mobile terminal within the workshop (current position); a position of the mobile terminal after the end of a previous motion period of the target motion period;
a current steering angle of the mobile terminal;
a current travel angle of the mobile terminal;
a current speed of the mobile terminal;
a current acceleration of the mobile terminal;
a current motion trajectory of the mobile terminal (the current motion trajectory is obtained by fitting based on the current position, the current steering angle, a steering angle of the mobile terminal after the end of the previous motion period of the target motion period, a speed of the mobile terminal after the end of the previous motion period of the target motion period, an acceleration of the mobile terminal after the end of the previous motion period of the target motion period, the current speed and the current acceleration, which can also be understood as a motion trajectory in the previous motion period of the target motion period).

Through the process of AGV active control, the problems of a high-speed AGV being unable to respond to the environment quickly and poor control performance are solved.

During the active control process, the duration of the target motion period is the first duration, and the first duration is determined based on the control environment state information within the workshop where the first mobile terminal is located. Generally speaking, the first duration is greater than the above preset duration.

The control environment state information (also referred to as real-time closed-loop control state) includes at least one of the following:
a safety distance between the first AGV and the second AGV;
an optimal speed of the first AGV; and
Closed-loop communication latency.

That is, during the active control process, the first mobile terminal adaptively adjusts the duration of the closed-loop interaction cycle time based on the control environment state information, and allocates a duration of active control decision and a duration of the passive control decision, which greatly reduces the number of accesses to the base station by AGVs and the communication overhead, expands the number of AGVs that can be controlled by the network, and improves production capacity of the workshop.

Through the main control process, the problem of high communication overhead and high closed-loop communication latency caused by frequent interactions between large-scale AGVs and the base stations is solved.

In summary, this step solves the problem of poor communication and control performance caused by heavy communication of large-scale intelligent machines in traditional closed-loop control schemes.

Further, after adjusting the motion trajectory and the motion speed of the first mobile terminal within the target motion period based on the sensor-sensed first motion state observation value of the first mobile terminal and/or the sensor-sensed second motion state observation value of the second mobile terminal, the method further includes:
sending a sensor-sensed third motion state observation value of the first mobile terminal to the communication network device; and
receiving a second control instruction sent from the communication network device, wherein the second control instruction is sent in response to determining that the communication network device determines, based on the sensor-sensed third motion state observation value and a preset motion trajectory, that a difference between the motion trajectory of the first mobile terminal and the preset motion trajectory is greater than a preset threshold, and wherein the second control instruction is used to instruct the first mobile terminal to perform adjustment based on the preset motion trajectory. The preset motion trajectory can be a motion trajectory pre-stored in the PLC device and can be understood as a normal motion trajectory of the AGV.

The difference between the motion trajectory of the first mobile terminal and the preset motion trajectory can be understood as an average of distances between several trajectory points on the motion trajectory of the first mobile terminal and several respective trajectory points on the preset motion trajectory, or a maximum distance among distances between several trajectory points on the motion trajectory of the first mobile terminal and several respective trajectory points on the preset motion trajectory.

That is, after each round of active control is completed, the first mobile terminal communicates with the communication network device, passively receives the control decision from the PLC device, and synchronizes and calibrates a travel trajectory, thus achieving rapid response to environment with low communication overhead.

It should also be noted that the above motion state observation value can be sent from the mobile terminal to the 5G base station, and then sent from the 5G base station to the PLC device.

The process of determining whether the AGV is located in the assembly area is described in detail below:

In one optional embodiment, the method further includes:
sensing, based on first sensor data on the first mobile terminal, the sensor-sensed first motion state observation value of the first mobile terminal within the workshop, that is, the first mobile terminal obtains its own sensor data, and obtains, based on the sensor data, the sensor-sensed first motion state observation value of the first mobile terminal within the workshop; and
determining whether the first mobile terminal meets the first condition based on the sensor-sensed first motion state observation value and pre-stored workshop map data, that is, the first mobile terminal matches a position of the mobile terminal within the workshop in the sensor-sensed first motion state observation value with the pre-stored workshop map data, and determines whether the current position is in the assembly area or in the steering area; in response to determining that the first mobile terminal determines that the first mobile terminal meets the first condition based on the sensor-sensed first motion state observation value and the pre-stored workshop map data, it is determined that the first mobile terminal meets the first condition, which is helpful for the subsequent selection of control decision; in response to determining that the first mobile terminal determines that the first mobile terminal does not meet the first condition based on the sensor-sensed first motion state observation value and the pre-stored workshop map data, the first mobile terminal receives an instruction (that is, the second instruction information) from the communication network device, wherein the communication network device determines whether the first condition is met.

Further, receiving the instruction information sent from the communication network device includes:
sensing the sensor-sensed first motion state observation value of the first mobile terminal within the workshop;
sending the first sensor data on the first mobile terminal and the first motion state observation value to the communication network device;
receiving the instruction information sent from the communication network device;
wherein, the communication network device is configured to receive second sensor data sent from sensors within the workshop; determine, from the second sensor data, third sensor data in which the first mobile terminal is observed; determine, from the third sensor data, a sensor-sensed fourth motion state observation value of the first mobile terminal; and process the sensor-sensed fourth motion state observation value to obtain a sensor-sensed fifth motion state observation value; and estimate a target motion state observation value of the first mobile terminal based on the sensor-sensed first motion state observation value and the sensor-sensed fifth motion state observation value, and determine whether the first mobile terminal meets the first condition based on the target motion state observation value and the pre-stored workshop map data.

Specifically, the 5G base station receives sensor data (i.e., the first sensor data) uploaded by the AGV via a wireless channel, as well as sensor data (i.e., the second sensor data) uploaded by the sensors within the workshop through an optical fiber. The above sensor data is sent from the 5G base station to the PLC device, to provide prior information for the control decision of the PLC. Then, after receiving the first sensor data and the second sensor data, the PLC device integrates them, estimates a motion state of the first mobile terminal, and further specifies the control decision.

The communication network device determines, from the second sensor data, the third sensor data in which a current motion state of the first mobile terminal is observed by M (M is an integer greater than or equal to 1) target sensors, denoted as {S₁, S₂, . . . , S_{M}}, and determines, from the third sensor data, the observed motion state Xₙ (i.e., the sensor-sensed fourth motion state observation value) of the first mobile terminal; and the PLC device processes the fourth state observation value to obtain the sensor-sensed fifth motion state observation value

$$\{ {X}_{n}^{1} , {X}_{n}^{2} , … , {X}_{n}^{M} \} ,$$

which meets:

$${X}_{n}^{i} = {X}_{n} + {N}_{n}^{i} ( 1 \leq i \leq M )$$

wherein,

$${N}_{n} ( {N}_{n} = ( {N}_{n}^{1} … {N}_{n}^{1} … {N}_{n}^{M} ) )$$

is a Gaussian white noise of the observation value, Nₙ˜N(0,σ²).

The state observation value sensed by the AGV itself is

$${X}_{n}^{0}$$

(the sensor-sensed first motion state observation value). The state of the AGV is estimated, by using a maximum likelihood estimation method, based on state observation values from different sensors and the state observation value sensed by the AGV itself. Based on the above assumptions, an estimated value \hat{X}ₙ (the target motion state observation value) of the Xₙ (Xₙ including the sensor-sensed first motion state observation value and the sensor-sensed fifth motion state observation value) can be expressed as:

$${\hat{X}}_{n} = \frac{1}{M + 1} {\sum }_{i = 0}^{m} {X}_{n}^{i}$$

that is, the sensor-sensed first motion state observation value and the sensor-sensed fifth motion state observation value are estimated by using the maximum likelihood estimation method to obtain the target motion state observation value.

A mean square error of the \hat{X}ₙ can be calculated as follows:

$${Δ}_{n} = E \{ {( {\hat{X}}_{n} - {X}_{n} )}^{2} \} = \frac{{σ}^{2}}{M + 1}$$

Specifically, due to the influence of the number and accuracy of sensing samples, there is a deviation between an actual position of the AGV and the sensed position of AGV. At the same time, due to a dynamic movement of the AGV, there is a lag between the sensed AGV position and environmental information, which leads to an increase in sensing error, and further affects control of the trajectory calibration, resulting in poor stability of the control system. Therefore, the above target motion state observation value is calculated based on combination of sensor data, so that the communication network device can more accurately determine whether the first mobile terminal meets the first condition based on the target motion state observation value.

The process of adjusting the motion speed of the first mobile terminal is described in detail below:

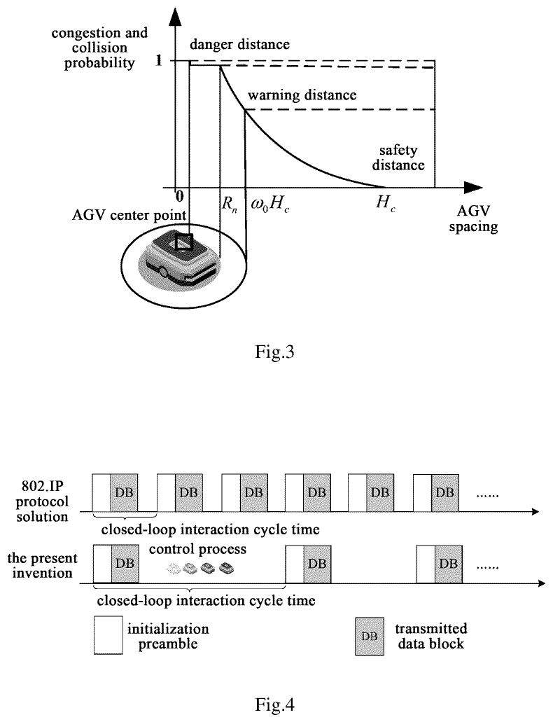

First, considering that the assembly lines are arranged in a annular shape and in parallel, all AGVs move in a cyclic step-by-step manner, and in this case, in the event of an AGV collision, an obstacle is defaulted to be another AGV. Furthermore, due to the AGV travel speed varies for AGVs of different sizes and working states, the AGV's safety area range can be adaptively varied. The congestion and collision probability varies for different AGV spacing, as shown in FIG. 3.

When an AGV is traveling on a reference trajectory (preset trajectory), collision between the AGV and an obstacle can be divided into the following three cases. As shown in FIG. 3, in a first case, when a Euclidean distance (spacing) H₀ between the AGV and an obstacle (an AGV preceding and adjacent to the AGV) is greater than the safety spacing H_{c}, the AGV is in the safe area; in a second case, when the spacing is in a warning range, i.e., ω₀H_{c}≤H₀≤H_{c}, there is a probability of a collision; in a third case, when the spacing is in a danger range, i.e., Rₙ≤H₀<ω₀H_{c}, there is a high probability of a collision and congestion. Furthermore, there is a further case, i.e., H₀<Rₙ, where a collision is inevitable. Wherein, ω₀ represents a collision warning threshold factor for the AGV, which is a preset value, and Rₙ represents a radius of an inscribed circle of a projection profile of the AGV on the ground.

In one optional embodiment, the sensor-sensed first motion state observation value includes a first position (current position) of the first mobile terminal within the workshop; the sensor-sensed second motion state observation value includes a second position (current position) of the second mobile terminal within the workshop.

The first position of the first mobile terminal can be represented by a center point of the first AGV, and the second position of the second mobile terminal can be represented by a center point of the second AGV.

Adjusting the motion speed of the first mobile terminal within the target motion period based on the sensor-sensed first motion state observation value of the first mobile terminal and/or the sensor-sensed second motion state observation value of the second mobile terminal includes:

obtaining a safety distance H_{c} based on a maximum speed of the first mobile terminal, a maximum acceleration of the first mobile terminal, a preset collision warning threshold factor ω₀, and a first radius Rₙ, wherein the first radius is a radius of an inscribed circle of a projection profile of the first mobile terminal on the ground, and the safety distance H_{c} is specifically expressed as follows:

$${H}_{c} = \frac{1}{{ω}_{0}} \cdot ( \frac{{v}_{max}^{2}}{2 {a}_{max}} + {R}_{n} ) = \frac{{v}_{max}^{2} + 2 {a}_{max} \cdot {R}_{n}}{{ω}_{0} \cdot 2 {a}_{max}}$$

wherein, aₘₐₓ is the maximum acceleration of the AGV, and vₘₐₓ is the maximum speed of the AGV;
obtaining a collision distance ω₀H_{c} (also referred to as a warning distance) based on the preset collision warning threshold factor ω₀ and the safety distance H_{c};
in response to determining that a Euclidean distance between the first position and the second position is greater than the safety distance, the first mobile terminal is controlled to accelerate within the target motion period, that is, in the above first case, the first mobile terminal is in the safety range, and accordingly the control decision is to execute an acceleration command in order to ensure the production efficiency of the assembly line while ensuring that the spacing is near the safety spacing;
in response to determining that the Euclidean distance between the first position and the second position is greater than or equal to the collision distance and less than the safety distance, the first mobile terminal is controlled to decelerate within the target motion period, that is, in the above second case, the control decision issues a deceleration command in order to avoid collision and to prevent carried parts from tipping over due to inertia;
in response to determining that the Euclidean distance between the first position and the second position is less than the collision distance, the first mobile terminal is controlled to perform emergency braking within the target motion period, that is, in the above third case, in response to determining that the spacing is in the danger range, the control instruction issues an emergency braking command.

In the embodiment of the present invention, a congestion probability function model for the third case and the above case where the collision is inevitable may be as follows:

$$Pr o ( {X}_{n} ) = \{ \begin{matrix}{e}^{1 - \frac{{H}_{0}}{{R}_{n}}} , {R}_{n} \leq {H}_{0} < {H}_{c} \\ 1 , {H}_{0} < {R}_{n}\end{matrix}$$

wherein exp(1−(H₀/Rₙ)) is a collision probability function constructed from a Euclidean distance between the AGV and an obstacle (the second AGV). It is assumed that when an AGVₙ (first mobile terminal) is traveling at a maximum speed vₘₐₓ and a spacing from the AGVₙ to a preceding vehicle decreases to ω₀H_{c}, an emergency braking command is executed. At this point, a speed of the AGVₙ will decrease from the maximum speed to 0, and after the AGVₙ stops, a distance from the AGVₙ to the preceding vehicle will be greater than or equal to Rₙ.

It should be noted that, considering that there is a visual blind spot when the AGV turns, the PLC needs to control the AGV based on real-time global information to prevent the risk of emergency collision that may occur outside the visibility range. Therefore, it is assumed that the AGV will issue a control request to the base station based on a typical service period when steering, completing or receiving a task, and passively receive a control decision from the PLC to adjust trajectory of the AGV itself.

In one optional embodiment, receiving the first control instruction sent from the communication network device includes:
after end of a first motion period, sending sensor-sensed the first motion state observation value of the first mobile terminal to the communication network device, wherein the sensor-sensed first motion state observation value includes a first position of the first mobile terminal within the workshop, and wherein the first motion period is a motion period preceding and adjacent to the target motion period; and
receiving the first control instruction from the communication network device;
wherein, in response to determining that the Euclidean distance between the first position and the second position is greater than a safety distance, the first control instruction is used to control the first mobile terminal to accelerate within the first motion period;
in response to determining that the Euclidean distance between the first position and the second position is greater than or equal to a collision distance and less than the safety distance, the first control instruction is used to control the first mobile terminal to decelerate within the first motion period;
in response to determining that the Euclidean distance between the first position and the second position is less than the collision distance, the first control instruction is used to control the first mobile terminal to perform emergency braking;
wherein the safety distance is obtained by the communication network device based on a maximum speed of the first mobile terminal, a maximum acceleration of the first mobile terminal, a preset collision warning threshold factor and a first radius, wherein the first radius is a radius of an inscribed circle of a projection profile of the first mobile terminal on the ground;
the collision distance is obtained based on the preset collision warning threshold factor and the safety distance;
the second position is sent from the second mobile terminal to the communication network device.

It should also be noted that the safety distance calculation process, the meaning of each parameter and the control content in this optional embodiment are consistent with the calculation process, the meaning of each parameter and the control content performed by the first mobile terminal in the above optional embodiment, with the only difference being that those in this optional embodiment are executed by the communication network device in this optional embodiment.

In this optional embodiment, the sensor-sensed first motion state observation value of the first mobile terminal can be sensed by the first mobile terminal and sent to the communication network device, and the communication network device calculates the first position of the first mobile terminal based on the sensor-sensed first motion state observation value. The second position of the second mobile terminal can be sensed by the second mobile terminal itself; or, the second mobile terminal can sense the second motion state observation value sensed by its own sensor and send it to the communication network device, and the communication network device calculates the second position based on the sensor-sensed second motion state observation value.

The process of adjusting the motion trajectory of the first mobile terminal is described in detail below:
in a dynamic environment within the non-assembly area, considering that the AGV will travel in a stable state along the annular assembly line, no robotic arm assembly stations or other obstacles are present between any AGVs. Therefore, the AGV in this area optimizes its own trajectory by taking the method of active local control decision as primary method and taking other AGVs as obstacle avoidance targets.

In one optional embodiment, the sensor-sensed first motion state observation value includes a first position, a first steering angle, a current speed and a current motion trajectory, of the first mobile terminal within the workshop;
adjusting the motion trajectory of the first mobile terminal within the target motion period based on the sensor-sensed first motion state observation value of the first mobile terminal includes:
   obtaining the motion trajectory of the first mobile terminal within the target motion period based on the current speed, an acceleration of the first mobile terminal, a duration of the target motion period, the first position, the first steering angle, the current motion trajectory and the first duration.

That is, when the AGV uploads sensed information to the PLC device next time (that is, before the start of the target motion period to the end of the target motion period), the motion trajectory expression for the AGV active closed-loop control is:

$${X}_{n} ( t + {T}_{ns}^{′} ) = {X}_{n} ( t ) + {T}_{ns}^{′} \cdot {J}^{′} ( t ) \cdot {V}_{n} ( t )$$

wherein, J′(t)=[aₓ a_{y} a_{φ}]⁻¹ is a binary discriminant factor for trajectory change in X-Y coordinates (i.e., the first position) and the steering angle (i.e., the first steering angle) of the AGV,

$${T}_{ns}^{′}$$

is a closed-loop interaction cycle time (i.e., the duration of the target motion period) of the

$${AGV}_{n} , {V}_{n} ( t ) = [ \begin{matrix}{v}_{n} ( t ) & {T}_{n}^{′} / 2 \cdot ( {dv}_{n} ( t ) / dt ) & {0 ]}^{- 1} ,\end{matrix}$$

wherein vₙ(t) is a speed of the AGVₙ at moment t (which can be understood as the current moment), and wherein

$${T}_{ns}^{′} / 2 \cdot ( {dv}_{n} ( t ) / dt )$$

is a function related to the acceleration.

The optimization of the motion trajectory, that is, a method for determining the acceleration, is described in detail below.

Further, the method further includes:
obtaining a time-dependent stability coefficient based on the first duration;
obtaining the acceleration of the first mobile terminal based on a communication latency, the safety distance, the maximum speed of the first mobile terminal and the stability coefficient.

It should be noted that, during active closed-loop control, since the AGV lacks global information from the PLC for trajectory calibration, it is necessary to design a trajectory optimization function based on the closed-loop interaction cycle time to calculate the control instruction to achieve rapid environmental response with low communication overhead.

Its trajectory optimization equation is:

$$\frac{{dv}_{n} ( t + {T}_{n}^{C} )}{dt} = κ [ V ( Δ {x}_{n - 1} ( t + {T}_{n}^{C} ) ) - {v}_{n} ( t + {T}_{n}^{C} ) ]$$

wherein

$${T}_{n}^{C}$$

is an end-to-end latency (i.e., the communication latency) during the AGV closed-loop communication process, κ=1/Tₙₛ′ is the time-dependent stability coefficient, Tₙₛ′ represents the duration of the target motion period, and V(Δxₙ₋₁(t)) is a speed function, i.e., V(Δxₙ₋₁(t)=(V max/2)·[tan h(Δxₙ₋₁−H_{c})+tan h(H_{c})]. Wherein H_{c} is the safe spacing between AGVs, and Vₘₐₓ represents the maximum motion speed of the AGV. It is assumed that the acceleration remains constant during the closed-loop interaction cycle time.

A final form of the AGV trajectory optimization function under the influence of the closed-loop interaction cycle time is obtained by expanding the equation and merging similar terms as follows:

$$\frac{{dv}_{n} ( t )}{dt} = α [ V ( Δ {x}_{n - 1} ( t ) ) - {v}_{n} ( t ) ] + β \frac{d Δ {x}_{n - 1} ( t )}{dt} + γ \frac{{d}^{2} Δ {x}_{n - 1} ( t )}{{dt}^{2}}$$

$$wherein ,$$

$$\begin{matrix}α = \frac{1}{{T}_{m}^{′} + {T}_{n}^{C}} \\ β = \frac{{T}_{n}^{C}}{{T}_{m}^{′} + {T}_{n}^{C}} {V}^{′} ( Δ {x}_{n - 1} ( t ) ) \\ γ = \frac{{( {T}_{n}^{C} )}^{2}}{2 ( {T}_{m}^{′} + {T}_{n}^{C} )} {V}^{′} ( Δ {x}_{n - 1} ( t ) )\end{matrix}$$

if the AGV can travel smoothly under offline active control and wait for a next closed-loop interaction cycle time to upload sensed data to the PLC and receive the control decision through the downlink to adjust the motion state to travel smoothly, a networked multi-node control with coordinated active and passive control is now completed.

It should be noted that, when the AGV senses that the AGV itself is in the assembly area, the AGV will also choose to passively receive the control decision from PLC to adjust its own motion trajectory, achieving high-precision control synchronization with the robotic arm. Therefore, in this area or the steering area, the AGV takes a mode of passively receiving control decision from PLC as primary mode, and moves slowly and with a high-precision in a cyclic step-by-step manner, to ensure efficient operation of production process.

In one optional embodiment, receiving the first control instruction sent from the communication network device includes:
sensing the sensor-sensed first motion state observation value of the first mobile terminal within the workshop based on first sensor data on the first mobile terminal; specifically, at the t-th moment, the AGVₙ transmits sensed data (first sensor data) and the first observation value obtained based on the first sensor data to the PLC device of the edge server through an uplink, that is, sends the sensor-sensed first motion state observation value to the communication network device, wherein the sensor-sensed first motion state observation value includes the current motion trajectory of the first mobile terminal;
receiving the first control instruction sent from the communication network device, wherein the first control instruction includes a second motion trajectory which is obtained by the communication network device based on a trajectory error, the trajectory error is an error between the current motion trajectory and a preset motion trajectory; specifically, the PLC device calculates the trajectory error |\hat{ε}ₙ(t) based on the current motion trajectory of the AGVₙ and a reference trajectory (the preset motion trajectory or a pre-stored motion trajectory), calibrates and compensates for the motion trajectory deviation, and generates a decision Xₙ(t) for a new round of vehicle traveling trajectory, namely the second motion trajectory, and then packages the result into the first control instruction nₙ(t) and sends it to the AGVₙ, thorough a downlink; and
adjusting the motion trajectory of the first mobile terminal within the target motion period based on the second motion trajectory, the preset duration, a first travel angle, and the current trajectory.

Wherein, the above first sensor data or the sensor-sensed first motion state observation value includes the coordinate (xₙ(t), yₙ(t)) of the first position of the first mobile terminal, a travel direction θₙ(t) (or referred to as the travel angle) of the first mobile terminal, and the like. Considering the influence of the sensing error on the control parameters, the trajectory error \hat{ε}ₙ(t) calculated by the PLC device includes the sensing error. At this point, after the AGVₙ receives a new first control instruction, a new travel trajectory is Xₙ(t+1), that is,

$${X}_{n} ( t + 1 ) = {X}_{n} ( t ) + {T}_{s} \cdot J \cdot {u}_{n} ( t )$$

wherein, Tₛ is a duration of an interval between two control instruction receptions from the PLC, that is, the duration of the target motion period,

$${u}_{n} ( t ) = f ( {X}_{n}^{r} ( t ) , {\hat{ε}}_{n} ( t ) )$$

is the trajectory control function for AGVₙ calculated by the PLC based on the reference trajectory and the trajectory error; and J is a transpose matrix, expressed as follows:

$$J ( t ) = ( \begin{matrix}cos {θ}_{n} ( t ) & 0 \\ sin {θ}_{n} ( t ) & 0 \\ 0 & 1\end{matrix} ) .$$

Afterwards, the first mobile terminal travels within the target motion period based on the new travel trajectory.

The matching process of the upper limit of the closed-loop interaction cycle time provided by an embodiment of the present invention is described in detail below.

In one optional embodiment, the method further includes:
determining the first duration based on a safety distance, a current speed at which the first mobile terminal is travelling and a closed-loop communication latency.

It should be noted that, during the closed-loop interaction of intelligent machines, through the analysis, it is found that an ability of the wireless network to respond to motion control request from AGV with low latency and high efficiency and an ability of controlling intelligent machines safely and stably in the control system have a mutual influence on each other. For example, when an AGV in a stable system state is traveling in a straight line along a flat assembly line, if sensed data and task-related data continuously uploaded K times by the AGV do not change the control decision transmitted from the PLC via downlink transmission, the AGV system is still in a stable state at this time, and then these data packets within the interaction cycle time are worthless and there is no need to transmit the data packets which would increase communication overhead and closed-loop latency. Based on this concept, the present invention reduces the quantity of service requests of the AGV per unit time by adaptively increasing the closed-loop interaction cycle time of the AGV while ensuring the system stable state, to support networked control of more AGVs.

Generally, the stability of the AGV control system refers to whether the motion state of an AGV in the system equilibrium state will automatically adjust back to an initial equilibrium state after being disturbed. If the system is unstable, the disturbance will spread, eventually leading to phenomena such AGV jam and collision, etc. If the system is stable, the disturbance will gradually decrease and disappear during propagation, and the vehicle spacing will remain at an optimal vehicle spacing after fluctuating for a period of time.

Therefore, the present invention analyzes the stability of the AGV control system under the influence of external interference by using a perturbation method. It is assumed that each group of AGVs is traveling along a straight line at a constant safety distance H₀ and at an optimal speed V(H₀) at moment t, then at this time, each AGV in the AGV control system is in a completely stable state. The initial position of the AGVₙ at the moment t is

$${x}_{i}^{( 0 )} ( t ) ,$$

to obtain:

$${x}_{n}^{( 0 )} ( t ) = n \cdot {H}_{0} + V ( {H}_{0} ) t$$

At the starting moment, a small disturbance yₙ(t) is added to the n-th AGV on any assembly line within the range of the base station, so that the AGV trajectory fluctuates and propagates backward. A trajectory deviation is denoted as:

$${x}_{n} ( t ) = n \cdot {H}_{0}^{′} + V ( {H}_{0}^{′} ) t + {y}_{n} ( t ) \\ {y}_{n} ( t ) = {x}_{n} ( t ) - {x}_{n}^{( 0 )} ( t ) \\ \frac{{d}^{2} {y}_{n} ( t )}{{dt}^{2}} = α [ V ( {H}_{0}^{′} ) Δ {y}_{n - 1} ( t ) - \frac{{dy}_{n} ( t )}{dt} ] + β \frac{d Δ {y}_{n - 1} ( t )}{dt} + γ \frac{{d}^{2} Δ {y}_{n - 1} ( t )}{{dt}^{2}} ,$$

wherein the disturbance term is expanded, that is yₙ(t)=exp(nki+zt), which is substituted into the above formula, and then similar terms are merged for simplifying to obtain a polynomial about z:

$$( 1 - γ {e}^{( ik )} ) {z}^{2} + [ α - β ( {e}^{( ik )} - 1 ) ] z - α {V}^{′} ( {H}_{0} ) ( {e}^{( ik )} - 1 ) = 0.$$

By the Taylor expansion of e^{ik}, the following is obtained:

$${e}^{ik} = 1 - ik + 0.5 \times {( ik )}^{2} .$$

z=z₁(ik)+z₂(ik)² is substituted into e^{ik}, to obtain a square term coefficient of ik as follows:

$${z}_{2} = {V}^{′} ( {H}_{0} ) [ \frac{1}{2} + \frac{{V}^{′} ( {H}_{0} ) ( γ - 1 ) + β}{α} ] .$$

If z₂=0, the AGV control system will be in a stable state.

Based on the stability coefficient (i.e. the above time-dependent stability coefficient)

$$κ = 1 / {T}_{ns}^{′} ,$$

the stability condition of the system model is obtained as:

$$κ \geq \frac{2 {{V}^{′} ( {H}_{0}^{′} )}^{2}}{1 + {{( {T}_{yn}^{C} )}^{2} [ {V}^{′} ( {H}_{0}^{′} ) ]}^{2} - 2 {{V}^{′} ( {H}_{0}^{′} )}^{2} {T}_{yn}^{C} + 2 {V}^{′} ( {H}_{0}^{′} ) {T}_{yn}^{C}} \approx {κ}_{th}$$

wherein,

$${T}_{yn}^{C}$$

represents a reference end-to-end latency (i.e., the closed-loop communication latency) for AGVs performing industrial tasks with different cycle times in the 3GPP standard, and V represents the current speed at which the first mobile terminal is travelling (i.e., the current speed). Let Z₂=0, to obtain a critical stability condition for the model to maintain stable operation under the disturbance. Since a control feedback latency of the AGV is much lower than the closed-loop latency and can be ignored, the upper limit of the closed-loop interaction cycle time in the stable state is:

$${\hat{T}}_{ns}^{′} \leq \frac{1 + {{( {T}_{yn}^{C} )}^{2} [ {V}^{′} ( {H}_{0}^{′} ) ]}^{2} - 2 {{V}^{′} ( {H}_{0}^{′} )}^{2} {T}_{yn}^{C} + 2 {V}^{′} ( {H}_{0}^{′} ) {T}_{yn}^{C}}{2 {{V}^{′} ( {H}_{0}^{′} )}^{2}} .$$

It can be seen that the AGV system can remain stable within the cycle time

$${\hat{T}}_{ns}^{′} ,$$

and the sensed data uploaded multiple times by the AGV within this cycle time does not affect the control decision of the edge server. Therefore, the upper limit

$${\hat{T}}_{ns}^{′}$$

of the closed-loop interaction cycle time in the above equation represents a maximum tolerable closed-loop interaction cycle time of the AGV under the condition of maintaining the system stable, that is, the maximum duration (i.e., the first duration) for which the AGV can ensure the stability of the control system without sending, to the server, the sensed data and a request for receiving control data.

Finally, a comparison of the duration of a traditional closed-loop interaction cycle time and the duration (i.e., the first duration) of the closed-loop interaction cycle time obtained by the present invention is shown in FIG. 4. As can be seen from FIG. 4, compared to traditional transmission mechanisms with 802.11P protocol such as Wi-Fi and Zigbee, the closed-loop interaction cycle time of the present invention is much longer than the fixed closed-loop interaction cycle time in traditional transmission mechanisms. This is because the transmission method of the present invention analyzes the impact of parameters such as the period duration, safety spacing distance, driving speed and the like on control stability, and a more flexible and less redundant transmission scheme with adaptive closed-loop interaction cycle time is designed. In particular, in the process of AGV moving in the non-assembly area, the closed-loop interaction cycle time of communication of the system's stable state with the base station is significantly increased, thus reducing the number of accesses to the base station by the AGV and communication overhead, and expanding the number of controllable AGVs in the network.

The performance of the method based on ISCC for closed-loop control of multiple intelligent machines in the embodiment of the present invention is illustrated by comparison in the following.

FIG. 5 shows a comparison of the number of controllable AGVs for different schemes, which compares the performance of the multi-AGV control system in a Traditional algorithm with Nmax Outage tolerance (TANOT), a Classic ISAC algorithm (CISACA), a Traditional algorithm (TA), and the design scheme of the present invention. As can be seen from the figure, when AGVs perform an industrial task with a reference interaction cycle time of 4 ms, the maximum number of AGVs that can be supported by the design scheme of the present invention is 100, significantly larger than the maximum numbers of AGVs, {60, 23, and 20}, that can be supported by TANOT, CISACA, and TA respectively. This is because TANOT ensures the stability of the AGV control system under the stability condition by calculating the number of AGV outages and retransmissions, aiming to reduce data access to the base station by AGVs. However, TANOT ignores the impact of sensing and control errors on communication latency during each outage and reconnection process, resulting in a limited effect on network load reduction. Although CISACA can reduce sensing and control errors through active sensing, it cannot effectively solve problems of packet collision, a high queuing delay and so on caused by the high-frequency access of large-scale AGVs to the base stations, and cannot optimize the number of AGVs. Due to the limited preamble, TA cannot support the access of large-scale AGVs to the base station, resulting in problems of packet collision, a high queuing delay and so on, and the number of AGVs supported by TA is also relatively small. In contrast, the design scheme of the present invention comprehensively considers the impact of sensing error and control error on communication transmission, calculates the upper limit of the closed-loop interaction cycle time in the stable state of the AGV control system, and enables more AGVs to participate in industrial tasks by adaptively adjusting the closed-loop interaction cycle time, which effectively reduces network load pressure.

Table 1 below shows a comparison of parameters, such as production efficiency performance, supportable maximum travel speed and so on, for traditional schemes such as TANOT, CISACA and TA and the design scheme of the present invention.

TABLE 1
Comparison of production efficiency performance

| | design scheme | | | |
|---|---|---|---|---|
| | of the present | TANOT | CISACA | TA |
| | invention | scheme | scheme | scheme |
| closed-loop interaction | 3.89 | 4.00 | 4.45 | 7.85 |
| latency (ms) | | | | |
| average speed of AGV | 4.75 | 3.56 | 3.09 | 3.73 |
| (m/s) | | | | |
| supportable AGV scale | 100 | 65 | 23 | 20 |
| production efficiency | 15.33 | 9.43 | 3.41 | 2.90 |
| (JPH) | | | | |

As can be seen from the table, the design scheme of the present invention achieves superior network performance, and the speed of AGVs and the number of AGVs that can be controlled by the wireless network are significantly greater than those of other schemes. This is because TANOT focuses on analyzing the impact of wireless network link outages on control stability. Although TANOT can reduce the number of AGV accesses to the base station to increase the number of AGVs that can be supported by the network; it ignores safety spacing and the sudden situation of emergency braking. Once an AGV is subjected to an external disturbance during each link outage, the probability of collision and congestion caused by the lose control of AGV speed is improved, and further the travel speed of AGVs and the number of AGVs and that can be supported by the system are limited. CISACA can reduce latency and error through active sensing, but it cannot effectively solve the problems of packet collision, a high queuing delay and so on caused by the high-frequency access of a large number of AGVs to the base station. CISACA cannot optimize the number of AGVs, and at the same time, the system design mechanism of CISACA does not pay attention to the impact of the AGV speed on the communication and control system, and cannot further effectively optimize the AGV speed. In this case, excessively slow travel speed leads to reduced production capacity. Similarly, TA cannot support the access of a large number of AGVs to the base station due to the limited preamble under the transmission mechanism with a fixed closed-loop interaction cycle time, which further results in the problems of packet collision, a high queuing delay and so on, and results in the small number of supportable AGVs, and an inability to optimize the AGV speed. However, on the one hand, the design scheme of the present invention comprehensively considers the impact of the communication-sensing-control closed-loop process on network performance, and adaptively adjusts the duration of the closed-loop interaction cycle time to reduce the number of AGV accesses to the base station and communication overhead, and simultaneously increases the number of AGVs that can be controlled by the network to ensure that the wireless communication system can enable the networked control of large-scale AGVs. In the other hand, the design scheme of the present invention comprehensively considers the impact of parameters, such as safety spacing, the closed-loop interaction cycle time and so on, on AGV control performance, and designs a networked multi-node control method with coordinated active control and passive control, to assist AGVs in intelligently selecting the active local decision or passively reception of control decision from PLC for trajectory control within different assembly areas, so as to reduce the probability of collision and congestion and ensure the safety and stability of the AGV control system. Furthermore, as shown in the table, the production capacity of the design scheme of the present invention is 15.33 JPH, while the production capacities of TANOT, CISACA and TA methods are 9.43 JPH, 3.41 JPH, and 2.90 JPH, respectively. The production capacity of the design scheme of the present invention is at least 62.6% higher than those of the latter, validating the effectiveness of the proposed scheme herein. In summary, simulation performance analysis demonstrates that AGV speed and the number of AGVs are key parameters affecting the production capacity of the final assembly workshop, and the production capacity can be effectively increased by adjusting the AGV speed and the number of AGVs.

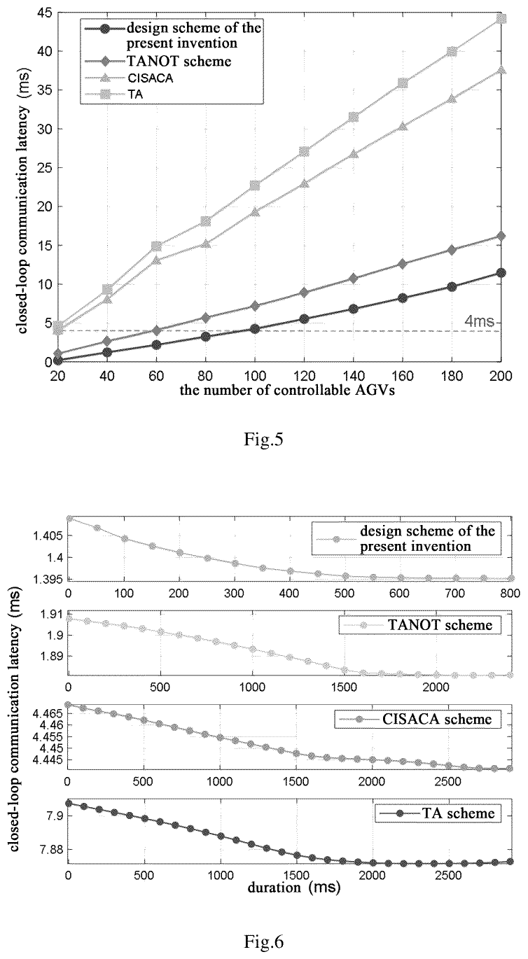

FIG. 6 compares closed-loop communication latencies for the four schemes. As can be seen from FIG. 6, the closed-loop latency of the design scheme of the present invention can converge and maintain system stable at 600 ms, which is much lower than 1600 ms for TANOT, 2600 ms for CISACA, and 2000 ms for TA. This is because TANOT optimizes the data retransmission process only based on a communication parameter SNR threshold, and reduces the closed-loop latency by marginally increasing a control instruction step size, which cannot effectively deal with a series of error changes caused by external interference, resulting in a slow convergence speed. CISACA can reduce some errors through active sensing, but it cannot quickly sense and reduce new control error generated in the AGV system under interference, which results in a slow convergence speed. Similarly, TA cannot deal with a series of error changes caused by external interferences, which results in a slow convergence speed. However, when all AGVs are disturbed, the design scheme of the present invention can quickly and actively optimize the trajectory of the AGVs locally, adaptively adjust the closed-loop interaction cycle time, reduce the number of user accesses to the base station per unit time, reduce data packet collision and queuing delay, further reduce the impact of the closed-loop latency on the stability coefficient, and accelerate the stability convergence speed, which verifies that the solution proposed herein has better anti-interference ability.

In addition, it can be seen from FIG. 6 that the closed-loop latency of the design scheme of the present invention is much lower than that of the other three schemes. This is because this scheme calculates the upper limit of the closed-loop interaction cycle time from the communication level by designing a system with collaborated communication-sensing-control, and adopts a more flexible transmission scheme with an adaptive closed-loop interaction cycle time. This improves the number of retransmissions and queuing delay, and intelligently selects active local decision and passive reception of control decision from PLC from the perspective of motion state control and environmental information sensing, thereby reducing the closed-loop latency with low communication overhead. The other three schemes discretely design optimization schemes with more demanding indicators and with high redundancy by respectively integrating communication and control, integrating communication and sensing, and from a single communication perspective, and ignore the mutual influence between the number of AGVs and the communication latency as well as between the AGV travel speed and the communication latency, and thus cannot effectively reduce the closed-loop latency. Furthermore, the figure shows that the closed-loop latency of the design scheme of the present invention is 1.3952 ms, while the closed-loop latencies of TANOT, CISACA and TA are 1.8811 ms, 4.4413 ms and 7.8727 ms, respectively. Compared with the performance of other classic schemes, the closed-loop latency of the scheme of the present invention has been improved by 25.83%, 68.59%, and 82.28%, respectively. This further verifies that the design scheme of the present invention has the best closed-loop latency performance improvement, enabling low-latency real-time control of AGVs.

In summary, the present invention can be applied to the closed-loop control field, referring to that in the intelligent manufacturing workshop, there are closed-loop control services with highly differentiated time-space, such as closed-loop control of intelligent machine and closed-loop management of the full life cycle of production line. This process involves communication, sensing, and control processes among numerous sensing devices, edge servers, and control devices, requiring flexible and efficient closed-loop control. The present invention can also be applied to the field of ISCC, referring to that the unified design of communication, sensing and control functions is achieved through the joint design of linear/nonlinear controllers, industrial wireless network protocols, networked collaborative sensing and other means, so that the wireless network can realize high-precision and refined sensing function as well as real-time and efficient control performance while performing high-quality communication interaction, and realize the improvement of the overall performance and service ability of the manufacturing workshop control system. The present invention can also be applied to the field of wireless networked control, referring to that the real-time monitoring and control of production lines, robots and Automated Guided Vehicle (AGV) is realized in combination with wireless communication and automatic control technology by using wireless network, to improve the production efficiency of intelligent manufacturing.

The method based on ISCC for closed-loop control of multiple intelligent machines provided by the present invention is a closed-loop control solution that can stably and efficiently control the high-speed movement of large-scale AGV in a networked manner, and ensure the quality of communication service while achieving the best control performance. This method is intended to integrate sensing, communication, and control functions to jointly design a closed-loop control method for multiple AGVs in a flexible manufacturing workshop, which reduces communication overhead while ensuring control system stability and production capacity.

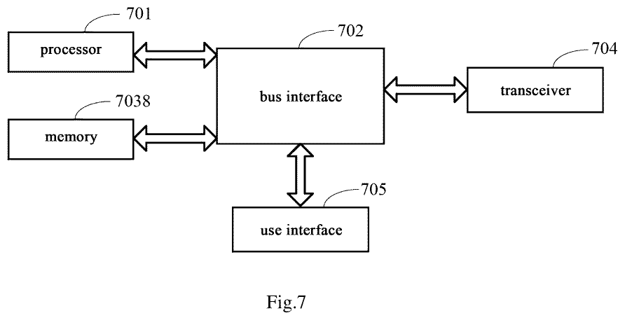

As shown in FIG. 7, an embodiment of the present invention further provides a device based on ISCC for closed-loop control of multiple intelligent machines, including a processor 701; a memory 703 connected to the processor 701 through a bus interface 701, wherein the memory 703 is configured to store programs and data used by the processor 701 when performing operations, and the processor 701 calls and executes the programs and data stored in the memory 703.

Wherein a transceiver 704 is connected to the bus interface 702 and is configured to receive and send data under the control of the processor 701. Specifically, the processor 701 is configured to read the programs in the memory 703, and the processor 701 carries out, when executing the programs, any method based on ISCC for closed-loop control of multiple intelligent machines in the above embodiments. Wherein, in FIG. 7, bus architecture can include any number of interconnected buses and bridges, specifically various circuits of one or more processors represented by the processor 701 and of memories represented by the memory 703 link together. The bus architecture can also link various other circuits together, such as a peripheral device, a voltage regulator, a power management circuit and so on, which are well known in the art, and thus will not be further described herein. The bus interface provides a user interface 705. The transceiver 74 may be a plurality of elements, i.e., includes a transmitter and a receiver, and provides a unit for communicating with various other devices on a transmission medium. The processor 701 is responsible for managing the bus architecture and general processing, and the memory 703 can store data used by the processor 701 when performing operations.

A readable storage medium according to an embodiment of the present invention has programs or instructions stored thereon, which when executed by a processor, cause the processor to carry out the above method based on ISCC for closed-loop control of multiple intelligent machines, and the same technical effect can be achieved. To avoid repetition, they will not be described here.

The above exemplary embodiments are described with reference to the accompanying drawings. Many different forms and embodiments are possible without departing from the spirit and teachings of the present invention. Therefore, the present invention should not be construed as limited to the exemplary embodiments set forth herein. Or rather, these exemplary embodiments are provided so that this disclosure will be complete and perfect and will convey the scope of the invention to those skilled in the art. In the drawings, component sizes and relative sizes may be exaggerated for clarity. The term used herein is for purposes of describing specific exemplary embodiments only and is not intended to be limiting. As used herein, the singular forms “a”, “an”, and “the” are intended to include plural forms, unless the context clearly indicates otherwise. It will be further understood that the terms “comprising” and/or “including” when used in this specification, indicate the presence of stated features, integers, steps, operations, members, and/or components, but do not preclude the presence or addition of one or more other features, integers, steps, operations, members, components, and/or groups thereof. Unless otherwise indicated, when stated, a range of a value includes the upper and lower limits of that range and any subranges there between.

The above descriptions are only preferred embodiments of the present invention. It should be pointed out that for those skilled in the art, several improvements and modifications can be made without departing from the principles of the present invention. These improvements and modifications should also be regarded as within the scope of protection of the present invention.

1. A method based on integrated sensing, communication, and control for closed-loop control of multiple intelligent machines, which is applied to a first mobile terminal, the method comprising:
in response to determining that the first mobile terminal meets a first condition, receiving a first control instruction sent from a communication network device, wherein the first control instruction is used to instruct to adjust a motion trajectory and a motion speed of the first mobile terminal within a target motion period, and wherein a duration of the target motion period is a preset duration; and
in response to determining that the first mobile terminal does not meet the first condition, adjusting the motion trajectory and the motion speed of the first mobile terminal within the target motion period based on a sensor-sensed first motion state observation value sensed of the first mobile terminal and/or a sensor-sensed second motion state observation value of a second mobile terminal, wherein the second mobile terminal is a motion terminal preceding and adjacent to the first mobile terminal, and wherein a duration of the target motion period is a first duration which is determined based on control environment state information within a workshop where the first mobile terminal is located;
wherein, the first condition comprises at least one of:
the first mobile terminal being located in an assembly area within the workshop; and
the first mobile terminal being located in a steering area on an assembly line within the workshop.

2. The method according to claim 1, wherein after adjusting the motion trajectory and the motion speed of the first mobile terminal within the target motion period based on the sensor-sensed first motion state observation value of the first mobile terminal and/or the sensor-sensed second motion state observation value of the second mobile terminal, the method further comprises:
sending a sensor-sensed third motion state observation value of the first mobile terminal to the communication network device; and
receiving a second control instruction sent from the communication network device, wherein the second control instruction is sent in response to determining that the communication network device determines, based on the sensor-sensed third motion state observation value and a preset motion trajectory, that a difference between the motion trajectory of the first mobile terminal and the preset motion trajectory is greater than a preset threshold, and wherein the second control instruction is used to instruct the first mobile terminal to perform adjustment based on the preset motion trajectory.

3. The method according to claim 1, wherein the method further comprises:
sensing, based on first sensor data on the first mobile terminal, the sensor-sensed first motion state observation value of the first mobile terminal within the workshop;
determining whether the first mobile terminal meets the first condition based on the sensor-sensed first motion state observation value and pre-stored workshop map data;
in response to determining that the mobile terminal determines that the first mobile terminal does not meet the first condition based on the sensor-sensed first motion state observation value and the pre-stored workshop map data, receiving instruction information sent from the communication network device, wherein the instruction information is used to indicate whether the first mobile terminal meets the first condition.

4. The method according to claim 3, wherein receiving the instruction information sent from the communication network device comprises:
sensing the sensor-sensed first motion state observation value of the first mobile terminal within the workshop;
sending the first motion state observation value to the communication network device;
receiving the instruction information sent from the communication network device;
wherein, the communication network device is configured to receive second sensor data sent by sensors within the workshop; determine, from the second sensor data, third sensor data in which the first mobile terminal is observed; determine, from the third sensor data, a sensor-sensed fourth motion state observation value of the first mobile terminal; and process the sensor-sensed fourth motion state observation value to obtain a sensor-sensed fifth motion state observation value, and estimate a target motion state observation value of the first mobile terminal based on the sensor-sensed first motion state observation value and the sensor-sensed fifth motion state observation value, and determine whether the first mobile terminal meets the first condition based on the target motion state observation value and the pre-stored workshop map data.

5. The method according to claim 1, wherein the sensor-sensed first motion state observation value comprises a first position of the first mobile terminal within the workshop; and the sensor-sensed second motion state observation value comprises a second position of the second mobile terminal within the workshop;
adjusting the motion speed of the first mobile terminal within the target motion period based on the sensor-sensed first motion state observation value of the first mobile terminal and/or the sensor-sensed second motion state observation value of the second mobile terminal comprises:
obtaining a safety distance based on a maximum speed of the first mobile terminal, a maximum acceleration of the first mobile terminal, a preset collision warning threshold factor and a first radius, wherein the first radius is a radius of an inscribed circle of a projection profile of the first mobile terminal on the ground;
obtaining a collision distance based on the preset collision warning threshold factor and the safety distance;
in response to determining that a Euclidean distance between the first position and the second position is greater than the safety distance, controlling the first mobile terminal to accelerate within the target motion period;
in response to determining that the Euclidean distance between the first position and the second position is greater than or equal to the collision distance and less than the safety distance, controlling the first mobile terminal to decelerate within the target motion period;
in response to determining that the Euclidean distance between the first position and the second position is less than the collision distance, controlling the first mobile terminal to perform emergency braking within the target motion period.

6. The method according to claim 1, wherein receiving the first control instruction sent from the communication network device comprises:
after an end of a first motion period, sending the sensor-sensed first motion state observation value of the first mobile terminal to the communication network device, wherein the sensor-sensed first motion state observation value comprises a first position of the first mobile terminal within the workshop, and wherein the first motion period is a motion period preceding and adjacent to the target motion period; and
receiving the first control instruction sent from the communication network device;
wherein, in response to determining that a Euclidean distance between the first position and a second position is greater than a safety distance, the first control instruction is used to control the first mobile terminal to accelerate within the target motion period;
in response to determining that the Euclidean distance between the first position and the second position is greater than or equal to a collision distance and less than the safety distance, the first control instruction is used to control the first mobile terminal to decelerate within the target motion period;
in response to determining that the Euclidean distance between the first position and the second position is less than the collision distance, the first control instruction is used to control the first mobile terminal to perform emergency braking within the target motion period;
wherein, the safety distance is obtained by the communication network device based on a maximum speed of the first mobile terminal, a maximum acceleration of the first mobile terminal, a preset collision warning threshold factor and a first radius, wherein the first radius is a radius of an inscribed circle of a projection profile of the first mobile terminal on the ground;
the collision distance is obtained based on the preset collision warning threshold factor and the safety distance;
the second position is sent from the second mobile terminal to the communication network device.

7. The method according to claim 1, wherein the sensor-sensed first motion state observation value comprises a first position, a first steering angle, a current speed and a current motion trajectory, of the first mobile terminal within the workshop;
adjusting a motion trajectory of the first mobile terminal within the target motion period based on the sensor-sensed first motion state observation value of the first mobile terminal comprises:
obtaining the motion trajectory of the first mobile terminal within the target motion period based on the current speed, an acceleration of the first mobile terminal, a duration of the target motion period, the first position, the first steering angle, the current motion trajectory and the first duration.

8. The method according to claim 7, wherein the method further comprises:
obtaining a time-dependent stability coefficient based on the first duration; and
obtaining the acceleration of the first mobile terminal based on a communication latency, a safety distance, a maximum speed of the first mobile terminal and the stability coefficient.

9. The method according to claim 1, wherein receiving the first control instruction sent from the communication network device comprises:
sensing the sensor-sensed first motion state observation value of the first mobile terminal within the workshop based on first sensor data on the first mobile terminal;
sending the sensor-sensed first motion state observation value to the communication network device, wherein the sensor-sensed first motion state observation value comprises a current motion trajectory of the first mobile terminal;
receiving the first control instruction sent from the communication network device, wherein the first control instruction comprises a second motion trajectory which is obtained by the communication network device based on a trajectory error, the trajectory error is an error between the current motion trajectory and a preset motion trajectory; and
adjusting the motion trajectory of the first mobile terminal within the target motion period based on the second motion trajectory, the preset duration, a first travel angle, and the current trajectory.

10. The method according to claim 1, wherein the method further comprises:
determining the first duration based on a safety distance, a current speed at which the first mobile terminal is travelling and a closed-loop communication latency.

11. A device based on integrated sensing, communication, and control for closed-loop control of multiple intelligent machines, comprising: a transceiver, a processor, a memory and programs or instructions stored in the memory and executable on the processor, wherein the programs or instructions, when executed by the processor, cause the processor to carry out operations of:
in response to determining that the first mobile terminal meets a first condition, receiving a first control instruction sent from a communication network device, wherein the first control instruction is used to instruct to adjust a motion trajectory and a motion speed of the first mobile terminal within a target motion period, and wherein a duration of the target motion period is a preset duration; and
in response to determining that the first mobile terminal does not meet the first condition, adjusting the motion trajectory and the motion speed of the first mobile terminal within the target motion period based on a sensor-sensed first motion state observation value sensed of the first mobile terminal and/or a sensor-sensed second motion state observation value of a second mobile terminal, wherein the second mobile terminal is a motion terminal preceding and adjacent to the first mobile terminal, and wherein a duration of the target motion period is a first duration which is determined based on control environment state information within a workshop where the first mobile terminal is located;
wherein, the first condition comprises at least one of:
the first mobile terminal being located in an assembly area within the workshop; and
the first mobile terminal being located in a steering area on an assembly line within the workshop.

12. The device according to claim 11, wherein, after adjusting the motion trajectory and the motion speed of the first mobile terminal within the target motion period based on the sensor-sensed first motion state observation value of the first mobile terminal and/or the sensor-sensed second motion state observation value of the second mobile terminal, the programs or instructions further cause the processor to carry out operations of:
sending a sensor-sensed third motion state observation value of the first mobile terminal to the communication network device; and
receiving a second control instruction sent from the communication network device, wherein the second control instruction is sent in response to determining that the communication network device determines, based on the sensor-sensed third motion state observation value and a preset motion trajectory, that a difference between the motion trajectory of the first mobile terminal and the preset motion trajectory is greater than a preset threshold, and wherein the second control instruction is used to instruct the first mobile terminal to perform adjustment based on the preset motion trajectory.

13. The device according to claim 11, wherein, the programs or instructions further cause the processor to carry out operations of:
sensing, based on first sensor data on the first mobile terminal, the sensor-sensed first motion state observation value of the first mobile terminal within the workshop;
determining whether the first mobile terminal meets the first condition based on the sensor-sensed first motion state observation value and pre-stored workshop map data;
if the first mobile terminal meets the first condition, determining that the first mobile terminal meets the first condition;
if the first mobile terminal does not meet the first condition, receiving instruction information sent from the communication network device, wherein the instruction information is used to indicate whether the first mobile terminal meets the first condition.

14. The device according to claim 13, wherein,
receiving the instruction information sent from the communication network device comprises:
sensing the sensor-sensed first motion state observation value of the first mobile terminal within the workshop;
sending the first motion state observation value to the communication network device;
receiving the instruction information sent from the communication network device;
wherein, the communication network device is configured to receive second sensor data sent by sensors within the workshop; determine, from the second sensor data, third sensor data in which the first mobile terminal is observed; determine, from the third sensor data, a sensor-sensed fourth motion state observation value of the first mobile terminal; and process the sensor-sensed fourth motion state observation value to obtain a sensor-sensed fifth motion state observation value, and estimate a target motion state observation value of the first mobile terminal based on the sensor-sensed first motion state observation value and the sensor-sensed fifth motion state observation value, and determine whether the first mobile terminal meets the first condition based on the target motion state observation value and the pre-stored workshop map data.

15. The device according to claim 11, wherein, the sensor-sensed first motion state observation value comprises a first position of the first mobile terminal within the workshop; and the sensor-sensed second motion state observation value comprises a second position of the second mobile terminal within the workshop;
adjusting the motion speed of the first mobile terminal within the target motion period based on the sensor-sensed first motion state observation value of the first mobile terminal and/or the sensor-sensed second motion state observation value of the second mobile terminal comprises:
obtaining a safety distance based on a maximum speed of the first mobile terminal, a maximum acceleration of the first mobile terminal, a preset collision warning threshold factor and a first radius, wherein the first radius is a radius of an inscribed circle of a projection profile of the first mobile terminal on the ground;
obtaining a collision distance based on the preset collision warning threshold factor and the safety distance;
in response to determining that a Euclidean distance between the first position and the second position is greater than the safety distance, controlling the first mobile terminal to accelerate within the target motion period;
in response to determining that the Euclidean distance between the first position and the second position is greater than or equal to the collision distance and less than the safety distance, controlling the first mobile terminal to decelerate within the target motion period;
in response to determining that the Euclidean distance between the first position and the second position is less than the collision distance, controlling the first mobile terminal to perform emergency braking within the target motion period.

16. The device according to claim 11, wherein, receiving the first control instruction sent from the communication network device comprises:
after an end of a first motion period, sending the sensor-sensed first motion state observation value of the first mobile terminal to the communication network device, wherein the sensor-sensed first motion state observation value comprises a first position of the first mobile terminal within the workshop, and wherein the first motion period is a motion period preceding and adjacent to the target motion period; and
receiving the first control instruction sent from the communication network device;
wherein, in response to determining that a Euclidean distance between the first position and a second position is greater than a safety distance, the first control instruction is used to control the first mobile terminal to accelerate within the target motion period;
in response to determining that the Euclidean distance between the first position and the second position is greater than or equal to a collision distance and less than the safety distance, the first control instruction is used to control the first mobile terminal to decelerate within the target motion period;
in response to determining that the Euclidean distance between the first position and the second position is less than the collision distance, the first control instruction is used to control the first mobile terminal to perform emergency braking within the target motion period;
wherein, the safety distance is obtained by the communication network device based on a maximum speed of the first mobile terminal, a maximum acceleration of the first mobile terminal, a preset collision warning threshold factor and a first radius, wherein the first radius is a radius of an inscribed circle of a projection profile of the first mobile terminal on the ground;
the collision distance is obtained based on the preset collision warning threshold factor and the safety distance;
the second position is sent from the second mobile terminal to the communication network device.

17. The device according to claim 11, wherein, the sensor-sensed first motion state observation value comprises a first position, a first steering angle, a current speed and a current motion trajectory, of the first mobile terminal within the workshop;
adjusting a motion trajectory of the first mobile terminal within the target motion period based on the sensor-sensed first motion state observation value of the first mobile terminal comprises:
obtaining the motion trajectory of the first mobile terminal within the target motion period based on the current speed, an acceleration of the first mobile terminal, a duration of the target motion period, the first position, the first steering angle, the current motion trajectory and the first duration.

18. The device according to claim 11, wherein, receiving the first control instruction sent from the communication network device comprises:
sensing the sensor-sensed first motion state observation value of the first mobile terminal within the workshop based on first sensor data on the first mobile terminal;
sending the sensor-sensed first motion state observation value to the communication network device, wherein the sensor-sensed first motion state observation value comprises a current motion trajectory of the first mobile terminal;
receiving the first control instruction sent from the communication network device, wherein the first control instruction comprises a second motion trajectory which is obtained by the communication network device based on a trajectory error, the trajectory error is an error between the current motion trajectory and a preset motion trajectory; and
adjusting the motion trajectory of the first mobile terminal within the target motion period based on the second motion trajectory, the preset duration, a first travel angle, and the current trajectory.

19. The device according to claim 11, wherein, the programs or instructions further cause the processor to carry out an operations:
determining the first duration based on a safety distance, a current speed at which the first mobile terminal is travelling and a closed-loop communication latency.

20. A non-transitory readable storage medium having programs or instructions stored thereon, which when executed by a processor, carry out the method based on integrated sensing, communication, and control for closed-loop control of multiple intelligent machines according to claim 1.
